(19) United States
(12) Patent Application Publication
(10) Pub. No.: US 2026/0336575 A1
(43) Pub. Date: Oct. 29, 2026

(54) BRAKE SYSTEM AND CONTROL METHOD THEREOF

(71) Applicant: HL MANDO CORPORATION, Pyeongtaek-si (KR)

(72) Inventor: Dongil SEO, Pyeongtaek-si (KR)

(73) Assignee: HL MANDO CORPORATION, Pyeongtaek-si (KR)

(21) Appl. No.: 19/382,914

(22) Filed: Nov. 7, 2025

(30) Foreign Application Priority Data
Apr. 28, 2025 (KR) 10-2025-0055787

(51) Int. Cl. B60T 8/172; B60T 8/171; B60T 13/74; F16D 55/226; F16D 65/18; F16D 66/00; F16D 121/24; F16D 127/06

(52) U.S. Cl. CPC B60T 8/172; B60T 8/171; B60T 13/746; F16D 55/226; F16D 65/18; F16D 66/00; B60T 2220/04; B60T 2240/00; F16D 2066/005; F16D 2121/24; F16D 2127/06

(57) ABSTRACT

A brake system comprises an electro-mechanical brake including a motor and a ratchet unit and configured to brake a wheel of a vehicle based on driving the motor and to engage a parking brake through operating the ratchet unit; and an electro-mechanical brake controller configured to control the motor and the ratchet unit, wherein the electro-mechanical brake controller is configured to control a torque of the motor so that a third clamping force, which is smaller than a first clamping force of the parking brake by a preset value, is generated based on the first clamping force and a second clamping force corresponding to a required braking force, in response to receiving the required braking force during engagement of the parking brake by the electro-mechanical brake.

### CROSS-REFERENCE TO RELATED APPLICATIONS

This application claims the benefit of Korean Patent Application No. 10-2025-0055787, filed on Apr. 28, 2025 in the Korean Intellectual Property Office, the disclosure of which is incorporated herein by reference.

### BACKGROUND

### Field

The present invention relates to a brake system and controlling method thereof.

### Description of the Related Art

A brake system for performing braking is essentially installed in a vehicle, and recently, Electro-Mechanical Brakes (EMB), which generate braking force by operating electric actuators such as motors based on electrical signals that convey the driver's braking intention, have been developed.

The electro-mechanical brake is a device that generates braking force using an electric actuator instead of hydraulic pressure, offering superior braking response and control performance compared to hydraulic brakes. In addition, the electro-mechanical brake allows for more efficient design and weight reduction, as well as easier maintenance compared to a hydraulic brake system.

Meanwhile, due to the structure of the electro-mechanical brake, when torque exceeding the clamping force of the parking brake is applied by the motor while the parking brake is engaged, the pawl may slip from the latch of the drive pulley, causing the parking brake to be disengaged.

This slippage can occur when the motor, responding to a service brake request, generates a torque that creates a clamping force exceeding the mechanical holding force of the engaged ratchet mechanism. This excessive force can overcome the engagement angle of the pawl and ratchet teeth, leading to an unintended release of the parking brake.

Additionally, when the parking brake of the electro-mechanical brake is engaged, if the required clamping force due to the driver's brake pedal pressure exceeds the clamping force of the parking brake, the parking brake may be unintentionally disengaged.

### SUMMARY

One aspect of the present disclosure is to provide a brake system and a control method thereof, which prevent unintended disengagement of the parking brake during engagement of the electro-mechanical parking brake and ensure responsiveness of the clamping force after disengagement of the parking brake.

For example, the brake system and the control method thereof may limit the parking brake from being disengaged even when a clamping force greater than that of the parking brake by the electro-mechanical brake is required due to the driver's brake pedal pressure or control by the brake system's controller. Additionally, the brake system and the control method thereof may ensure responsiveness of the clamping force after disengagement of the parking brake.

According to one aspect of the present disclosure, there is provided a brake system comprising: an electro-mechanical brake including a motor and a ratchet unit and configured to brake a wheel of a vehicle based on driving the motor and to engage a parking brake through operating the ratchet unit; and an electro-mechanical brake controller configured to control the motor and the ratchet unit, wherein the electro-mechanical brake controller is configured to control a torque of the motor so that a third clamping force, which is smaller than a first clamping force of the parking brake by a preset value, is generated based on the first clamping force and a second clamping force corresponding to a required braking force, in response to receiving the required braking force during engagement of the parking brake by the electro-mechanical brake.

The electro-mechanical brake controller may control the torque of the motor so that the third clamping force is generated based on the second clamping force being equal to or greater than the first clamping force.

Engagement of the parking brake may be maintained while the torque of the motor is controlled to generate the third clamping force.

The electro-mechanical brake controller may control the torque of the motor so that the engagement of the parking brake is released, based on receiving a disengagement request for the parking brake from a controller of the brake system during control of the torque of the motor so that the third clamping force is generated.

The electro-mechanical brake controller may increase the torque of the motor based on receiving the disengagement request for the parking brake from the controller of the brake system, during control of the torque of the motor so that the third clamping force is generated.

The electro-mechanical brake controller may control the torque of the motor so that the second clamping force corresponding to the required braking force is generated in response to the disengagement of the parking brake.

The brake system may comprise a current sensor configured to detect current of the motor, and the electro-mechanical brake controller may determine the first clamping force based on the current of the motor acquired through a signal output from the current sensor.

The electro-mechanical brake may include a caliper brake comprising a pad plate configured to press a brake disc that rotates together with the wheel.

The brake system may comprise a force sensor configured to detect a clamping force caused by contact between the brake disc and the brake pad, and the electro-mechanical brake controller may determine the first clamping force based on a signal output from the force sensor.

The brake system may further comprise a controller electrically or communicatively connected to a pedal displacement sensor configured to detect a displacement of a brake pedal and a wheel speed sensor configured to detect a speed of the wheel, and the controller may transmit the required braking force to the electro-mechanical brake controller based on receiving a signal output from the pedal displacement sensor or the wheel speed sensor.

According to one aspect of the present disclosure, there is provided a control method of a brake system comprising an electro-mechanical brake including a motor and a ratchet unit and configured to brake a wheel of a vehicle based on driving the motor and to engage a parking brake through operating the ratchet unit, the control method comprising: receiving a required braking force during engagement of the parking brake by the electro-mechanical brake; and controlling a torque of the motor so that a third clamping force, which is smaller than a first clamping force of the parking brake by a preset value, is generated based on the first clamping force and a second clamping force corresponding to the required braking force, in response to receiving the required braking force

The controlling of the torque of the motor so that the third clamping force may be performed based on the second clamping force being equal to or greater than the first clamping force.

Engagement of the parking brake may be maintained while the torque of the motor is controlled to generate the third clamping force.

The control method may further comprise controlling the torque of the motor so that the engagement of the parking brake is released, based on receiving a disengagement request for the parking brake from a controller of the brake system during control of the torque of the motor so that the third clamping force is generated.

The controlling of the torque of the motor so that the engagement of the parking brake is released may include increasing the torque of the motor.

The control method may further comprise controlling the torque of the motor so that the second clamping force corresponding to the required braking force is generated in response to the disengagement of the parking brake.

The first clamping force may be determined based on current of the motor obtained through a signal output from a current sensor configured to detect the current of the motor.

The electro-mechanical brake may include a caliper brake comprising a pad plate configured to press a brake disc that rotates together with the wheel.

The first clamping force may be determined based on a signal output from a force sensor configured to detect a clamping force caused by contact between the brake disc and the brake pad.

The required braking force may be generated based on a signal output from a pedal displacement sensor configured to detect a displacement of a brake pedal or a wheel speed sensor configured to detect a speed of the wheel.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating the configuration of a brake system according to an embodiment of the present disclosure.

FIG. 2 is a simplified cross-sectional view of a caliper brake according to an embodiment of the present disclosure.

FIG. 3 is a simplified perspective view of an actuator assembly of an electro-mechanical brake according to an embodiment of the present disclosure.

FIG. 4 is a cross-sectional view illustrating a ratchet unit and a first drive pulley of the actuator assembly according to an embodiment of the present disclosure.

FIG. 5 is a flowchart illustrating the operation of an electro-mechanical brake controller of the brake system according to an embodiment of the present disclosure.

FIG. 6 is a graph illustrating the clamping force according to control of a conventional electro-mechanical brake.

FIG. 7 is a graph illustrating the clamping force according to control of an electro-mechanical brake according to an embodiment of the present disclosure.

FIG. 8 is a graph illustrating the clamping force according to control of an electro-mechanical brake according to an embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. The present specification does not describe all elements of the embodiments, and any content that is general in the technical field to which the present disclosure belongs or that overlaps between the embodiments is omitted. The terms “portion, module, element, or block” used in the specification may be implemented in software or hardware, and according to the embodiments, a plurality of “portions, modules, elements, or blocks” may be implemented as a single element, or a single “portion, module, element, or block” can include a plurality of elements.

Throughout the specification, when a part is said to be “connected” to another part, this includes not only direct connection but also indirect connection, and indirect connection includes connection via a wireless communications network.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

Hereinafter, the operating principle and embodiments of the present disclosure will be described with reference to the attached drawings.

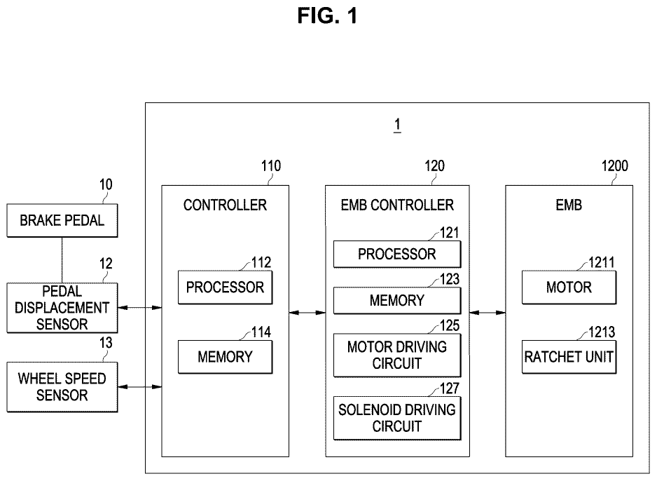

FIG. 1 is a diagram illustrating the configuration of a brake system according to an embodiment of the present disclosure.

Referring to FIG. 1, the brake system 1 may include a controller 110, an electro-mechanical brake controller 120, and an electro-mechanical brake 1200.

The controller 110 may be electrically or communicatively connected to the electro-mechanical brake controller 120 and may transmit control signals to the electro-mechanical brake controller 120.

For example, although not shown in FIG. 1, the controller 110 may include a communication circuit.

The controller 110 may be electrically or communicatively connected to a pedal displacement sensor 12 for a brake pedal 10 of the vehicle and/or a wheel speed sensor 13 provided on a wheel of the vehicle.

The controller 110 may receive signals output from the pedal displacement sensor 12 and/or the wheel speed sensor 13.

The pedal displacement sensor 12 may detect the displacement of the brake pedal 10 or acquire displacement information.

For example, the pedal displacement sensor 12 may be physically connected to the brake pedal 10 and may measure the movement of the brake pedal 10.

The pedal displacement sensor 12 may detect the displacement distance and/or the movement speed of the brake pedal 10 from a reference position.

The pedal displacement sensor 12 may transmit an electrical signal corresponding to the displacement distance and/or movement speed of the brake pedal 10 to the controller 110.

The wheel speed sensor 13 may detect the speed of the corresponding wheel (also referred to as the rotational speed of the wheel).

The wheel speed sensor 13 may transmit an electrical signal corresponding to the rotational speed of the wheel to the controller 110.

The controller 110 may generate a requested braking force based on signals received from the pedal displacement sensor 12 and/or the wheel speed sensor 13.

The controller 110 may transmit a control signal including the requested braking force to the electro-mechanical brake controller 120.

The controller 110 may provide a control signal for engagement of the parking brake by the electro-mechanical brake 1200 to the electro-mechanical brake controller 120 based on receiving a signal indicating vehicle stop identification or a parking switch (not shown).

For example, the controller 110 may identify the vehicle's stopped state based on information obtained through signals output from a speed sensor that acquires the vehicle speed and/or the wheel speed sensor 13, and may provide a parking brake engagement control signal to the electro-mechanical brake controller 120 based on the identification of the vehicle's stopped state.

In addition, the controller 110 may provide a parking brake engagement control signal to the electro-mechanical brake controller 120 based on receiving a signal output from a parking switch operated by the driver.

The controller 110 may provide a parking brake disengagement control signal to the electro-mechanical brake controller 120 based on receiving a signal output from a parking switch (not shown).

The controller 110 may be referred to as a Brake Control Unit (BCU) and may include an Electronic Control Unit (ECU).

The controller 110 may include a processor 112 and/or a memory 114.

The processor 112 may process output signals from the pedal displacement sensor 12 and/or the wheel speed sensor 13 to determine a requested braking force.

The processor 112 may generate a control signal including the target braking clamping force, which is based on the requested braking force, and transmit the control signal to the electro-mechanical brake controller 120.

The processor 112 may transmit parking brake engage and disengage signals (also referred to as apply and release signals) to the electro-mechanical brake controller 120.

The memory 114 may store programs and data for implementing operations to control components included in the brake system 100 by the processor 112.

The memory 114 may provide the stored programs and data to the processor 112 and may store temporary data generated during the operation of the processor 112.

For example, the memory 114 may include volatile memory such as static random access memory (S-RAM) and dynamic random access memory (D-RAM), and non-volatile memory such as read-only memory (ROM), erasable programmable read-only memory (EPROM), electrically erasable programmable read-only memory (EEPROM), and flash memory.

The electro-mechanical brake controller 120 may receive a requested braking force from the controller 110 and may control the electro-mechanical brake 1200 based on the requested braking force, for example, by controlling the torque of the motor 1211.

The electro-mechanical brake controller 120 may receive a parking brake engagement control signal and/or disengagement control signal from the controller 110, and may control the electro-mechanical brake 1200 to engage and/or disengage the parking brake based on the engagement and/or disengagement control signal.

The electric mechanical brake controller 120 may identify a clamping force generated according to the contact between the pad plates 211 and 213 and the brake disk 200, i.e., when the pad plates 211 and 213 press the brake disk 200, based on the reception of a signal output from a current sensor (not shown) provided to sense the current of the motor 1211.

The electric mechanical brake controller 120 may identify a clamping force generated according to the contact between the pad plates 211 and 213 and the brake disk 200 based on the reception of the signal output from the force sensor (not shown) detecting the clamping force according to the contact between the pad plates 211 and 213 and the brake disk 200.

The electro-mechanical brake controller 120 may include a processor 121, a memory 123, a motor driving circuit 125, and/or a solenoid driving circuit 127.

The processor 121 may convert a target braking clamping force of the electro-mechanical brake 1200 into torque of a motor 1211 of the electro-mechanical brake 1200, and may generate a signal to control the motor 1211.

The processor 121 may generate a signal to control the motor 1211 and/or a signal to control a ratchet unit 1213 of an actuator assembly 1210, which will be described later, for controlling engagement and/or disengagement of the parking brake of the electro-mechanical brake 1200.

The memory 123 may store programs and data for implementing operations to control components included in the electro-mechanical brake 1200 by the processor 121.

For example, the memory 123 may include volatile memory such as static random access memory (S-RAM) and dynamic random access memory (D-RAM), and non-volatile memory such as read-only memory (ROM), erasable programmable read-only memory (EPROM), electrically erasable programmable read-only memory (EEPROM), and flash memory.

The motor driving circuit 125 may drive a motor 1211 of the electro-mechanical brake 1200 based on a control signal from the processor 121. For example, the motor driving circuit 125 may receive a signal from the processor 121 and adjust the current of the motor 1211. According to the adjustment of the current of the motor 1211, the speed and torque of the motor 1211 may be controlled.

The solenoid driving circuit 127 may drive a solenoid driving unit 301 included in the ratchet unit 1213 of the electro-mechanical brake 1200 based on a control signal from the processor 121. The solenoid driving circuit 127 may receive a signal from the processor 121 and provide an electrical signal to cause the solenoid coil 3011 to generate a magnetic field.

The electro-mechanical brake 1200 may perform braking force generation, parking brake engagement, and/or parking brake disengagement based on reception of a control signal from the electro-mechanical brake controller 120.

The electro-mechanical brake 1200 may include a motor 1211 and a ratchet unit 1213.

The motor 1211 has a rotary shaft, and the electro-mechanical brake 1200 may generate braking force according to the rotational driving force of the motor 1211.

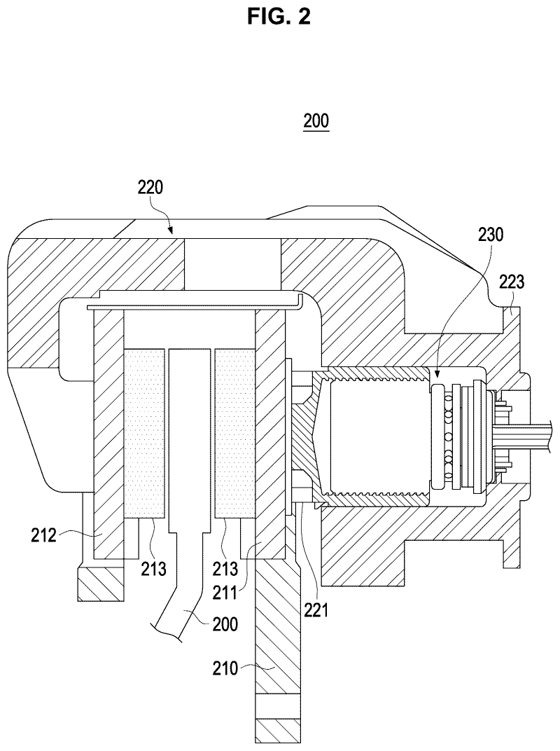

The electro-mechanical brake 1200 may include a caliper brake as shown in FIG. 2.

FIG. 2 is a simplified cross-sectional view of a caliper brake according to an embodiment of the present disclosure.

Referring to FIG. 2, the caliper brake 200 may include a brake disk that rotates with the corresponding wheel, a pair of pad plates 211 and 212 that are provided to pressurize the brake disk 200, a brake pad 213 attached to one surface of each of the pair of pad plates 211 and 212 and, more specifically to one surface facing the brake disk 200, a carrier 210 provided with a pair of pad plates 211 and 212 to move forward and backward, a caliper housing 220 equipped with a cylinder 223 that is installed slidably in the carrier 210 and where the piston 221 is installed to move forward and backward by an actuating force generated by a power conversion unit 230, the power conversion unit 230 pressurizing the piston 221, a motor (not shown) (1211 of FIG. 1) with a rotary shaft and/or a motor actuator (not shown) that transmits rotational force to the power conversion unit 230 using the motor.

According to the above-described configuration, the rotational driving force of the motor(s) 1211 is transmitted to the pad plates 211 and 212 through the power conversion unit 230 and the transmitted rotational driving force moves the pad plates 211 and 212 forward and backward to press the brake disk 200, thereby enabling the corresponding electro-mechanical brake 1200 to generate braking force.

The ratchet unit 1213 prevents reverse rotation of the electro-mechanical brake 1200 according to the rotational driving force of the motor 1211, thereby ensuring stable braking force and enabling the implementation of a parking brake that engages the electro-mechanical brake 1200.

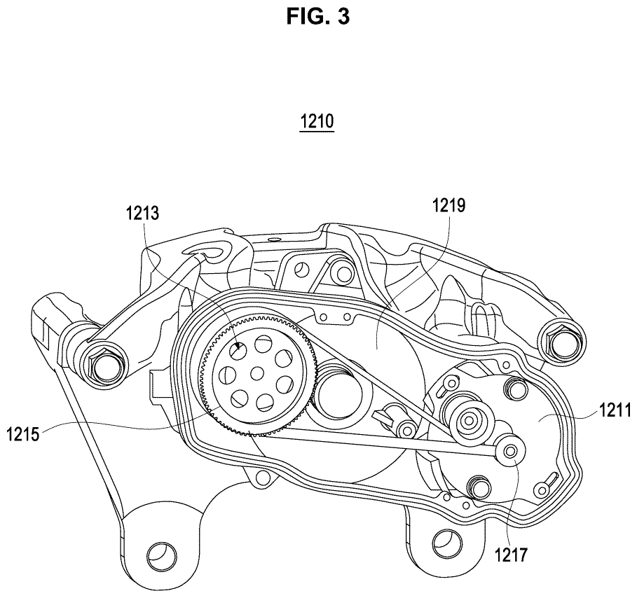

The motor 1211 and the ratchet unit 1213 may be implemented as a single actuator assembly, as shown in FIG. 3.

FIG. 3 is a simplified perspective view of an actuator assembly of an electro-mechanical brake according to an embodiment of the present disclosure.

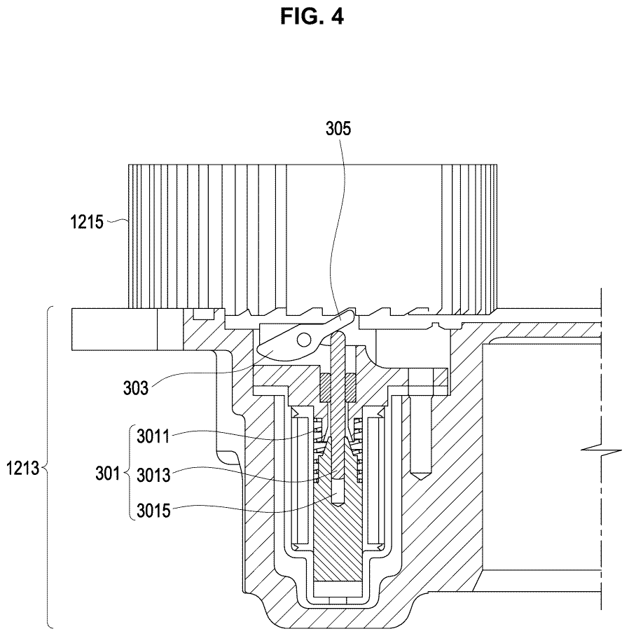

FIG. 4 is a cross-sectional view illustrating a ratchet unit and a first drive pulley of the actuator assembly according to an embodiment of the present disclosure.

Referring to FIG. 3, the actuator assembly 1210 of the electro-mechanical brake 1200 may include a motor 1211, a ratchet unit 1213, a first drive pulley 1215 (also referred to as a driven pulley), a second drive pulley 1217 (also referred to as a driving pulley), and a belt 1219.

The second drive pulley 1217 may be connected to the rotor shaft of the motor 1211, and the first drive pulley 1215 may be fixed by the ratchet unit 1213.

The first drive pulley 1215 and the second drive pulley 1217 may be rotatably connected to each other through a belt 1219.

According to the above-described configuration, the rotational driving force of the motor 1211 is transmitted to the first drive pulley 1215 through the second drive pulley 1217, so that the parking brake may be engaged or disengaged.

Meanwhile, referring to FIG. 4, the ratchet unit 1213 may include a solenoid actuator 301, a pawl 303, and/or a torsion spring 305.

The solenoid actuator 301 may rotate the pawl 303 so that the pawl 303 engages or disengages with the sawtooth of the first drive pulley 1215.

The solenoid actuator 301 may include a solenoid coil 3011, an armature 3013, and/or a pin 3015.

The solenoid coil 3011 can generate a magnetic field in response to an electrical signal from the electro-mechanical brake controller 120.

The armature 3013 can move linearly forward and backward inside the solenoid coil 3011 due to the magnetic field generated by the solenoid coil 3011. The forward and backward movement of the armature 3013 can cause the pawl 303 to move so that it engages or disengages with the sawtooth of the first drive pulley 1215, which is disposed above the ratchet unit 1213.

The pin 3015 is press-fitted into the armature 3013 and can push the pawl 303 according to the movement of the armature 3013.

The pawl (303) is moved by the armature (3013) and may engage or disengage with the sawtooth of the first drive pulley (1215).

The pawl (303) can engage with the sawtooth of the first drive pulley (1215) to engage the parking brake, or move so as not to engage with the sawtooth to implement the disengagement of the parking brake.

The torsion spring (305) is provided on the pawl (303) and can provide an elastic force that pushes the pawl (303) away from the first drive pulley (1215).

The first drive pulley 1215 may receive driving power from the motor 1211 and rotate, and the rotational force of the first drive pulley 1215 may implement engagement or disengagement of the parking brake.

For example, the first drive pulley 1215 may include sawtooth-shaped protrusions, and when the pawl 303 is seated in the groove of the sawtooth-shaped protrusions, the parking brake may be engaged; otherwise, the parking brake may be disengaged.

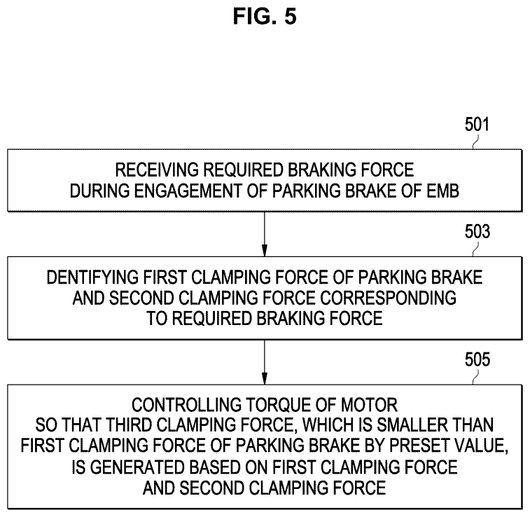

FIG. 5 is a flowchart illustrating the operation of an electro-mechanical brake controller 120 of the brake system 1 according to an embodiment of the present disclosure.

Referring to FIG. 5, the brake controller 120 may receive a required braking force from the controller 110 during the engagement of the parking brake of the electro-mechanical brake 1200 (501).

For example, the controller 110 may transmit the required braking force to the electro-mechanical brake controller 120 based on a signal output from the pedal displacement sensor 12 and/or a signal output from the wheel speed sensor 13.

The brake controller 120 may identify a first clamping force of the parking brake and a second clamping force corresponding to the required braking force in response to receiving the required braking force from the controller 110 (503).

The brake controller 120 may identify the first clamping force of the parking brake based on a signal received from a current sensor configured to detect a current of the motor 1211 or from a force sensor configured to detect a clamping force generated by the contact between the pad plates 211 and 213 and the brake disc 200.

The brake controller 120 may identify a second clamping force corresponding to the required braking force based on pre-stored clamping force information corresponding to each required braking force.

The brake controller 120 may control the torque of the motor 1211 so that a third clamping force, which is smaller than a first clamping force of the parking brake by a preset value, is generated based on the first clamping force and the second clamping force (505).

The brake controller 120 may control the torque of the motor 1211 so that a third clamping force is generated when the second clamping force is equal to or greater than the first clamping force, thereby preventing unintended disengagement of the parking brake.

In addition, in addition to the above-described embodiment of FIG. 5, the brake controller 120 may control the torque of motor 1211 to release the parking brake, for example, increase the torque of motor 1211 to release the parking brake based on the reception of the parking brake release request from controller 110 while controlling the torque of motor 1211 to generate a third clamping force.

In addition, the brake controller 120 may control the torque of the motor 1211 so that a second clamping force corresponding to the required braking force received in operation 501 is generated, in response to the disengagement of the parking brake.

According to the above-described embodiments, it is possible to solve the conventional problem in which the parking brake is unintentionally disengaged during control of a conventional electro-mechanical brake.

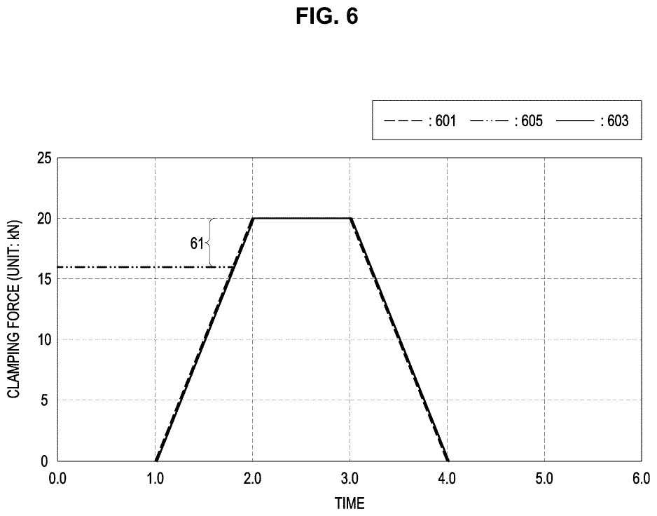

FIG. 6 is a graph illustrating the clamping force according to control of a conventional electro-mechanical brake.

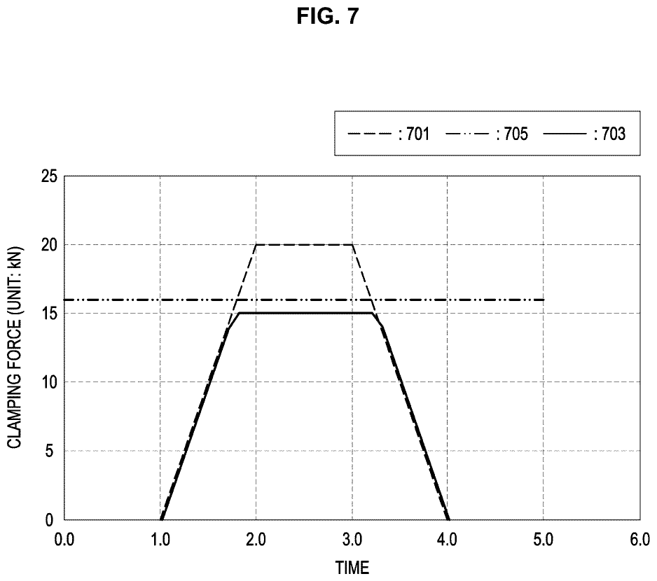

FIG. 7 is a graph illustrating the clamping force according to control of an electro-mechanical brake according to an embodiment of the present disclosure.

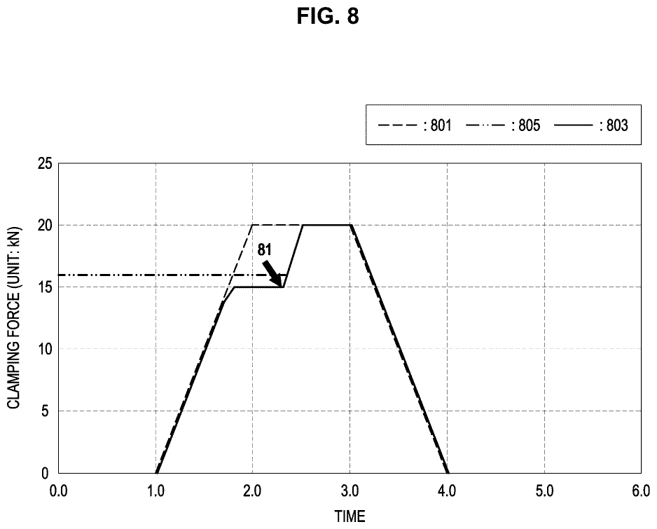

FIG. 8 is a graph illustrating the clamping force according to control of an electro-mechanical brake according to an embodiment of the present disclosure.

In a state in which the parking brake is engaged by the electro-mechanical brake, a required braking force for the service brake may be additionally generated by pressing the brake pedal by the driver or the like.

Conventionally, as shown in FIG. 6, when the motor of the electro-mechanical brake operates according to a required clamping force (601) (also referred to as a second clamping force) based on the required braking force while the parking brake is engaged by the electro-mechanical brake, an unintended problem of the parking brake being disengaged may occur in a situation (61) where the actual clamping force (603) (also referred to as a third clamping force) generated by the motor exceeds the clamping force (605) (also referred to as a first clamping force) of the engaged parking brake.

To address the conventional problem described above, referring to FIG. 7, the electro-mechanical brake controller 120 according to the aforementioned embodiments may control the torque of the motor 1211 of the electro-mechanical brake 1200 so that the clamping force 603 generated by the motor 1211 does not exceed the clamping force 605 of the engaged parking brake, when a second clamping force 601 corresponding to a required braking force equal to or greater than the first clamping force 605 of the engaged parking brake is generated while the parking brake is engaged by the electro-mechanical brake 1200.

For example, the electro-mechanical brake controller 120 may control the torque of the motor 1211 so that a third clamping force 603, which is smaller than the first clamping force 605 by a preset value, is generated while the second clamping force 601 is equal to or greater than the first clamping force 605.

Accordingly, the parking brake engagement can be maintained while controlling the torque of the motor 1211 to generate the third clamping force 603.

Additionally, referring to FIG. 8, while controlling the torque of motor 1211 to generate the third clamping force 603, if a request to disengage the parking brake is received from controller 110 (81), the brake controller 120 may increase the torque of motor 1211 to increase the third clamping force 603 and thereby disengage the parking brake. Thereafter, the electro-mechanical brake controller 120 may control the torque of motor 1211 to follow the second clamping force 601 according to the required braking force.

Accordingly, the electro-mechanical brake controller 120 may secure control responsiveness upon a release request of the parking brake.

The brake system and its control method according to the above-described embodiments may provide a technology capable of preventing the unintended disengagement of the parking brake, when excessive required clamping force occurs due to the driver's pressing of the brake pedal or from the brake system controller during the engaged state of the parking brake by the electro-mechanical brake.

The brake system and its control method according to the above-described embodiments may provide a technology capable of ensuring responsiveness when a request to disengage the parking brake by the electro-mechanical brake is made.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A brake system comprising:
an electro-mechanical brake including a motor and a ratchet unit and configured to brake a wheel of a vehicle based on driving the motor and to engage a parking brake through operating the ratchet unit; and
an electro-mechanical brake controller configured to control the motor and the ratchet unit,
wherein the electro-mechanical brake controller is configured to control a torque of the motor so that a third clamping force, which is smaller than a first clamping force of the parking brake by a preset value, is generated based on the first clamping force and a second clamping force corresponding to a required braking force, in response to receiving the required braking force during engagement of the parking brake by the electro-mechanical brake.

2. The brake system of claim 1, wherein the electro-mechanical brake controller is configured to control the torque of the motor so that the third clamping force is generated based on the second clamping force being equal to or greater than the first clamping force.

3. The brake system of claim 2, wherein engagement of the parking brake is maintained while the torque of the motor is controlled to generate the third clamping force.

4. The brake system of claim 2, wherein the electro-mechanical brake controller is configured to control the torque of the motor so that the engagement of the parking brake is released, based on receiving a disengagement request for the parking brake from a controller of the brake system during control of the torque of the motor so that the third clamping force is generated.

5. The brake system of claim 4, wherein the electro-mechanical brake controller is configured to increase the torque of the motor based on receiving the disengagement request for the parking brake from the controller of the brake system, during control of the torque of the motor so that the third clamping force is generated.

6. The brake system of claim 4, wherein the electro-mechanical brake controller is configured to control the torque of the motor so that the second clamping force corresponding to the required braking force is generated in response to the disengagement of the parking brake.

7. The brake system of claim 1, further comprising:
a current sensor configured to detect current of the motor, and
wherein the electro-mechanical brake controller is configured to determine the first clamping force based on the current of the motor acquired through a signal output from the current sensor.

8. The brake system of claim 1, wherein the electro-mechanical brake includes a caliper brake comprising a pad plate configured to press a brake disc that rotates together with the wheel.

9. The brake system of claim 8, further comprising:
a force sensor configured to detect a clamping force caused by contact between the brake disc and the brake pad, and
wherein the electro-mechanical brake controller is configured to determine the first clamping force based on a signal output from the force sensor.

10. The brake system of claim 1, further comprising:
a controller electrically or communicatively connected to a pedal displacement sensor configured to detect a displacement of a brake pedal and a wheel speed sensor configured to detect a speed of the wheel, and
wherein the controller is configured to transmit the required braking force to the electro-mechanical brake controller based on receiving a signal output from the pedal displacement sensor or the wheel speed sensor.

11. A control method of a brake system comprising an electro-mechanical brake including a motor and a ratchet unit and configured to brake a wheel of a vehicle based on driving the motor and to engage a parking brake through operating the ratchet unit, the control method comprising:
receiving a required braking force during engagement of the parking brake by the electro-mechanical brake; and
controlling a torque of the motor so that a third clamping force, which is smaller than a first clamping force of the parking brake by a preset value, is generated based on the first clamping force and a second clamping force corresponding to the required braking force, in response to receiving the required braking force.

12. The control method of claim 11, wherein the controlling of the torque of the motor so that the third clamping force is performed based on the second clamping force being equal to or greater than the first clamping force.

13. The control method of claim 12, wherein engagement of the parking brake is maintained while the torque of the motor is controlled to generate the third clamping force.

14. The control method of claim 12, further comprising:
controlling the torque of the motor so that the engagement of the parking brake is released, based on receiving a disengagement request for the parking brake from a controller of the brake system during control of the torque of the motor so that the third clamping force is generated.

15. The control method of claim 14, wherein the controlling of the torque of the motor so that the engagement of the parking brake is released includes:
increasing the torque of the motor.

16. The control method of claim 14, further comprising:
controlling the torque of the motor so that the second clamping force corresponding to the required braking force is generated in response to the disengagement of the parking brake.

17. The control method of claim 11, wherein the first clamping force is determined based on current of the motor obtained through a signal output from a current sensor configured to detect the current of the motor.

18. The control method of claim 11, wherein the electro-mechanical brake includes a caliper brake comprising a pad plate configured to press a brake disc that rotates together with the wheel.

19. The control method of claim 18, wherein the first clamping force is determined based on a signal output from a force sensor configured to detect a clamping force caused by contact between the brake disc and the brake pad.

20. The control method of claim 11, wherein the required braking force is generated based on a signal output from a pedal displacement sensor configured to detect a displacement of a brake pedal or a wheel speed sensor configured to detect a speed of the wheel.
